(19) United States
(12) Patent Application Publication
(10) Pub. No.: US 2006/0221199 A1
(43) Pub. Date: Oct. 5, 2006

(54) Digital camera and image processing method

(75) Inventor: Yasumasa Nakajima, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/239,224

(22) Filed: Sep. 30, 2005

(30) Foreign Application Priority Data
Sep. 30, 2004 (JP) 2004-287247

(51) Int. Cl. H04N 5/228

(52) U.S. Cl. 348/222.1; 348/333.11

(57) ABSTRACT

A digital camera includes: a shooting unit that generates, in accordance with a shooting operation, raw data representing a tone level of one channel per pixel; a first generating unit that generates a first image from the raw data; and a second generating unit that generates a second image from the raw data more precisely than the first generating unit with an algorithm that is different from that of the first generating unit.

### CROSS-REFERENCE TO RELATED APPLICATION

The entire disclosure of Japanese Patent Application No. 2004-287247 (filed on Sep. 30, 2004), including the specification, drawings and abstract, is incorporated by reference in this application.

### BACKGROUND OF THE INVENTION

1. Field of the Invention

The present invention relates to a digital camera and an image processing method, and in particular to technology that generates an image from raw data.

2. Description of the Related Art

Conventional digital cameras usually execute the following processing to store a color image in a nonvolatile storage medium such as a removable memory. First, the digital camera AD-converts an analog output signal from a color image sensor to generate raw data representing a tone level of any one channel of R, G and B in regard to the pixels of the color image sensor, and stores the raw data in a volatile storage medium. Usually, the raw data include the maximum image information that the digital camera can acquire as digital data from the subject. Next, the digital camera generates, from the raw data, an output-use image representing the tone levels of three channels in regard to each pixel and stores the output-use image in the volatile storage medium. In the process by which the output-use image is generated from the raw data, pixel interpolation, concentration conversion, resolution conversion and spatial information conversion are administered on the basis of the shooting conditions that the user sets before shooting. Next, the digital camera compresses the output-use image and stores it in a nonvolatile storage medium in a predetermined format. In this manner, in the process by which the compressed output-use image is generated from the raw data, various kinds of irreversible conversions are administered.

As disclosed in JP-A-11-261933 and JP-A-2004-96500, digital cameras are known which can record raw data in nonvolatile storage media. Digital cameras are also known which generate an output-use image after shooting from the raw data once the raw data have been stored in the nonvolatile storage media. Such digital cameras can set the conditions after shooting and generate an output-use image from the raw data.

Incidentally, conventional digital cameras generate an output-use image with the same algorithm when generating the output-use image in accordance with the shooting operation and when generating the output-use image in accordance with an operation after the shooting operation. Conventional digital cameras also give priority to speeding up image generation processing at the expense, to a certain extent, of image quality in order to shorten the continuous shooting interval. Incidentally, it is not always the case that the continuous shooting interval is important in the use environment of the digital camera. For example, when shooting scenery, oftentimes no problems arise even if the continuous shooting interval is long. Also, for example, when the user is trying to generate an output-use image by reading the raw data stored in the nonvolatile storage medium, there is no intent on the part of the user to immediately try to shoot.

### SUMMARY OF THE INVENTION

The present invention has been made in view of the above, and it is an object thereof to provide a digital camera that can generate an image in a short amount of time from raw data and can also generate a high-quality image from the raw data.

(1) A digital camera according to the invention for achieving this object comprises: a shooting unit that generates, in accordance with a shooting operation, raw data representing a tone level of one channel per pixel; a first generating unit that generates a first image from the raw data; and a second generating unit that generates a second image from the raw data more precisely than the first generating unit with an algorithm that is different from that of the first generating unit.

According to this invention, because the digital camera is disposed with the second generating unit that generates an image from the raw data more precisely than the first generating unit with an algorithm that is different from that of the first generating unit, a high-quality image can be generated from the raw data. According to this invention, because the digital camera is disposed with the first generating unit that generates an image from the raw data more imprecisely than the second generating unit, an image can be formed from the raw data in a short amount of time.

(2) The second generating unit may realize, with software, a function that a dedicated circuit configuring at least part of the first generating unit realizes.

According to this invention, when the second generating unit generates an image, it uses more processing resulting from software in comparison to when the first generating unit generates an image. Thus, flexible processing corresponding to the characteristics of the raw data becomes possible. Specifically, for example, an image can be precisely generated in accordance with the characteristics of the raw data by detailed conditional branch processing of a computer program executed by a general-purpose circuit.

(3) The number of pixels of the shooting unit corresponding to data that the second generating unit references in order to automatically set a processing condition for generating the second image may be greater than the number of pixels of the shooting unit corresponding to data that the first generating unit references in order to automatically set a processing condition for generating the first image.

According to this invention, when an image is generated by the second generating unit from the raw data on the basis of the automatically set processing condition, data corresponding to more pixels are referenced in comparison to when an image is generated by the first generating unit. Thus, a high-quality image can be generated.

(4) The processing condition may be used in white balance correction.

(5) The processing condition may be used in brightness correction.

(6) The processing condition may be used in memory color correction. Memory color correction is correction that brings image regions of color close to skin color, sky blue color and leaf green color, for which humans have specific fixed concepts, closer to colors corresponding to those fixed concepts.

(7) The processing condition may be used in image compression.

(8) The number of pixels of the shooting unit corresponding to data that the second generating unit references in order to generate one pixel of the second image may be greater than the number of pixels of the shooting unit corresponding to data that the first generating unit references in order to generate one pixel of the first image.

According to this invention, when one pixel is generated from the raw data, the second generating unit references data corresponding to more pixels than the first generating unit. Thus, a high-quality image can be generated.

(9) The digital camera may further comprise an output unit that output data to a nonvolatile storage medium. The first generating unit may generate the first image in accordance with the shooting operation. The second generating unit may generate, from the raw data stored in the nonvolatile storage medium, the second image in accordance with a development request after the shooting operation. The output unit may store, in the nonvolatile storage medium and in accordance with the shooting operation, at least one of the raw data that the shooting unit has generated and the first image that the first generating unit has generated in accordance with the shooting operation, and store, in the nonvolatile storage medium and in accordance with the development request, the second image that the second generating unit has generated.

According to this invention, an image is generated by the first generating unit in accordance with the shooting operation, and at least one of the generated image and the raw data is stored in the nonvolatile storage medium by the output unit. Thus, the continuous shooting interval can be reduced, and the raw data stored in the nonvolatile storage medium can be accessed after the shooting operation. Also, according to this invention, an image is generated by the second generating unit and the generated image is stored in the nonvolatile storage medium by the output unit with respect to a development request executed after the shooting operation. Thus, a high-quality image can be stored in the nonvolatile storage medium.

(10) The digital camera may further comprise a setting unit that receives, after the shooting operation, a setting operation of a generation condition for the second generating unit to generate the second image, and sets the generation condition in accordance with the setting operation, and a display control unit that displays, on a screen and before receiving the setting operation of the generation condition, the first image stored in the nonvolatile storage medium.

According to this invention, the image stored in the nonvolatile storage medium can be confirmed on the screen before the setting operation of the generation condition for generating an image after the shooting operation with the second generating unit. Thus, the user can easily set an appropriate generation condition.

(11) The digital camera may further comprise a volatile storage medium and an output unit that stores data in a nonvolatile storage medium. The shooting unit may store the raw data in the volatile storage medium in accordance with the shooting operation. The first generating unit may generate, from the raw data stored in the volatile storage medium, the first image in accordance with the shooting operation. The second generating unit may generate, from the raw data stored in the volatile storage medium, the second image in accordance with a development request after the shooting operation. The output unit may store, in the nonvolatile storage medium and in accordance with the shooting operation, the first image that the first generating unit has generated, and store, in the nonvolatile storage medium and in accordance with the development request, the second image that the second generating unit has generated.

According to this invention, an image is generated by the first generating unit in accordance with the shooting operation and the generated image is stored in the nonvolatile storage medium by the output unit. Thus, the continuous shooting interval can be shortened. Also, according to this invention, when a development request is conducted after the shooting operation, an image is generated by the second generating unit from the raw data stored in the volatile storage medium in accordance with the shooting operation, and the generated image is stored in the nonvolatile storage medium by the output unit. Thus, even if the raw data are not stored in the nonvolatile storage medium, a high-quality image can be stored in the nonvolatile storage medium.

(12) The digital camera may further comprise a setting unit that receives, after the shooting operation, a setting operation of a generation condition for the second generating unit to generate the second image, and sets the generation condition in accordance with the setting operation, and a display control unit that displays, on a screen and before receiving the setting operation of the generation condition, the first image stored in the nonvolatile storage medium.

According to this invention, the image stored in the nonvolatile storage medium can be confirmed on the screen before the setting operation of the generation condition for generating an image after the shooting operation with the second generating unit. Thus, the user can easily set an appropriate generation condition.

(13) The digital camera may further comprise a pre-shooting selection unit that receives, before the shooting operation, a pre-shooting selection operation for selecting either the first image or the second image, and causes, in accordance with the pre-shooting selection operation, either the first generating or the second generating unit to generate the first image or the second image in accordance with the shooting operation.

According to this invention, the user can select either the first generating unit or the second generating unit in accordance with the status at the time of shooting. Thus, in accordance with the status at the time of shooting, an image can be generated in a short amount of time and in accordance with the shooting operation, and a high-quality image can be generated in accordance with the shooting operation.

(14) The digital camera may further comprise a post-shooting selection unit that receives, after the shooting operation, a post-shooting selection operation for selecting either the first image or the second image, and causes, in accordance with the post-shooting selection operation, either the first generating or the second generating unit to generate the first image or the second image.

According to this invention, when an image is generated from the raw data after the shooting operation, the user can select either the first generating unit or the second generating unit. Thus, in accordance with the status at the time of a development request, an image can be generated in a short amount of time, and an image can be precisely generated.

(15) An image processing method according to the invention for achieving the above-described object is an image processing method of generating an image with a digital camera, the method comprising: a shooting step that generates, in accordance with a shooting operation, raw data representing a tone level of one channel per pixel; a first generating step that generates a first image from the raw data; and a second generating step that generates a second image from the raw data more precisely than the first generating unit with an algorithm that is different from that of the first generating step.

According to this invention, an image can be generated in a short amount of time from the raw data, and an image can be precisely generated from the raw data.

The various functions of the plural units with which the invention is disposed are realized by a hardware resource whose functions are specified by the configuration itself, or by a hardware resource whose functions are specified by a program, or by a combination of these. Also, each of the various functions of the plural units is not limited to being realized by hardware resources that are physically independent of each other. Also, the present invention can not only be specified as a device, but also as a program or a recording medium in which that program is stored.

### BRIEF DESCRIPTION OF THE DRAWINGS

The drawings portray embodiments reflecting the principle of the invention in the form of simplified schematic diagrams. Many elements and details that will be easily understood by those skilled in the art have been omitted so that the invention does not become unclear.

FIG. 1 is a flow chart showing an image processing method pertaining to a first embodiment of the invention.

FIG. 2 is a block diagram showing a digital camera pertaining to the first embodiment of the invention.

FIG. 3 is a rear view showing the digital camera pertaining to the first embodiment of the invention.

FIG. 4 is a block diagram showing an image processing program pertaining to the first embodiment of the invention.

FIG. 5 is a diagram showing a data structure pertaining to the first embodiment of the invention.

FIG. 6 is a diagram showing transition between screens pertaining to the first embodiment of the invention.

FIG. 7 is a flow chart showing an image processing method pertaining to a second embodiment of the invention.

FIG. 8 is a flow chart showing the image processing method pertaining to the second embodiment of the invention.

FIG. 9 is a flow chart showing the image processing method pertaining to the second embodiment of the invention.

### DETAILED DESCRIPTION OF THE INVENTION

Embodiments of the present invention will be described below on the basis of several embodiments. Constituent elements having the same reference numerals in the embodiments correspond to constituent elements having those reference numerals in other embodiments. The embodiments will be described in detail, but the present invention is not limited to these embodiments and will be recognized as including a very wide scope. The attached claims should be referenced to determine the true scope of the invention.

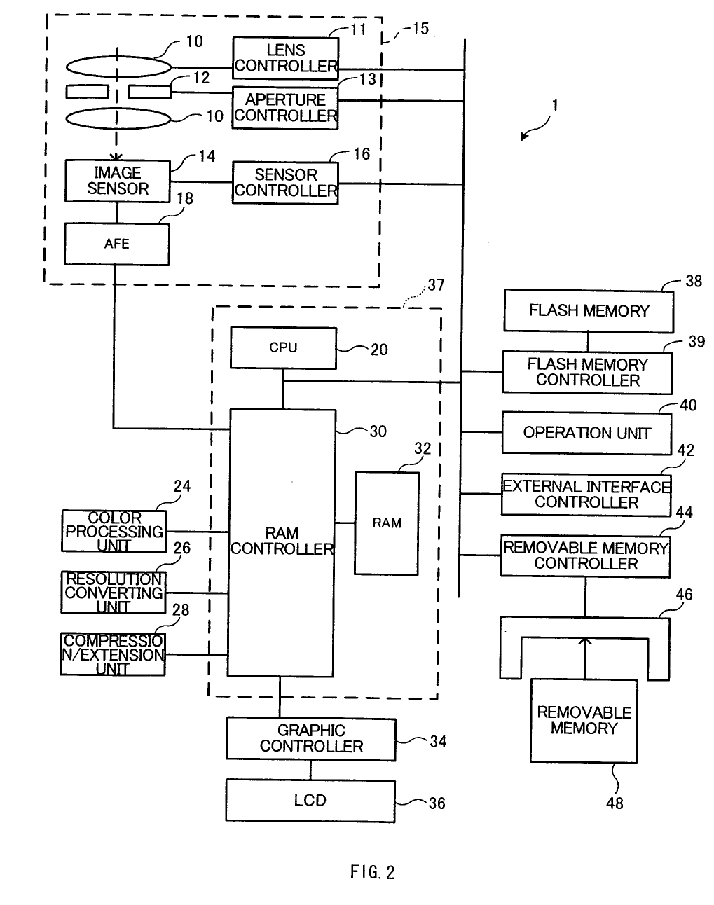

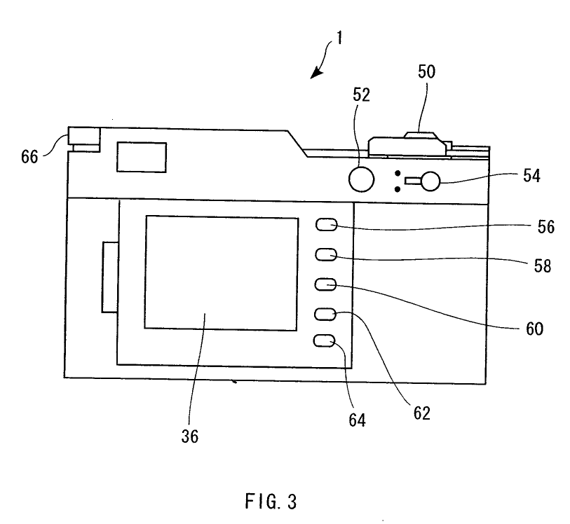

FIG. 2 is a block diagram showing a digital still camera (DSC) 1 according to an embodiment of the invention. FIG. 3 is a rear view of the DSC 1.

An image sensor 14 is a color shooting element disposed with charge transfer devices such as a CCD (Charge Coupled Device) and photoelectric transducers discretely arranged in two-dimensional space, and is a so-called CCD color image sensor or a CMOS color image sensor. The image sensor 14 outputs an electrical signal corresponding to the gray in an optical image imaged on a light-receiving surface by lenses 10 and an aperture 12. Because the image sensor 14 is disposed with color filters in a Bayer array per photoelectric transducer, it outputs an electrical signal representing the tone level of any one channel of RGB per pixel. The lenses 10 are driven by a lens controller 11 and reciprocally move in the light axis direction. The aperture 12 is driven by an aperture controller 13 and adjusts the quantity of light made incident on the image sensor 14. The time in which an electrical charge is accumulated in the image sensor 14 (shutter speed) may be controlled by a mechanical shutter, or may be controlled electrically by the ON/OFF of a gate signal of the image sensor 14. A sensor controller 16 outputs, to the image sensor 14, pulse signals such as a gate signal and a shift signal at a predetermined timing and drives the image sensor 14.

An analog front end (AFE) 18 administers AD conversion with respect to the analog electrical signal outputted from the image sensor 14 to generate raw data. The raw data are usually data in which the analog electrical signals outputted from the shooting elements are simply digitalized. Consequently, the raw data represent the tone level of any one channel of RGB per pixel. For this reason, the raw data are not an image and cannot be used to display an image in which a subject is recognizable, even if the raw data are displayed as is. However, the raw data may be data to which has been administered some concentration conversion usually administered at the time of image formation, such as exposure correction and white balance correction, or may be data to which some concentration conversion has not been administered. The raw data outputted from the AFE 18 are stored in a RAM 32 by a RAM controller 30.

The above-described lenses 10, aperture 12, image sensor 14, lens controller 11, aperture controller 13, sensor controller 16 and AFE 18 are constituent elements of a shooting unit 15 that configures the shooting unit described in the claims.

A color processing unit 24 serving as a first generating unit and a second generating unit works with a control unit 37 to administer development processing with respect to the raw data outputted from the AFE 18. The development processing is processing that forms an image having tone levels of three channels of RGB per pixel by interpolating, at neighboring pixels, the tone levels of the pixels of the raw data corresponding to the accumulated electrical charges of the photoelectric transducers. Usually, the processing time takes longer to reference neighboring pixels positioned in a relatively wide range around a target pixel and calculate the tone level of each channel of the target pixel in comparison to when referencing neighboring pixels in a narrow range. Consequently, in the development processing immediately after shooting, the continuous shooting interval can be shortened by referencing neighboring pixels in a relatively narrow range and calculating the tone level of the target pixel. When the user does not intend to conduct a next shooting, a high-quality image can be formed by referencing neighboring pixels of a relatively wide range and calculating the tone level of the target pixel.

In the development processing, spatial information conversion and various types of gray conversion such as sharpness correction, brightness correction, contrast correction, white balance correction, and memory color correction can be administered. For example, by administering sharpness correction with respect to an image that is blurry due to unsteadiness at the time of shooting, an image that is blurry due to unsteadiness can be corrected to a sharp image. By administering sharpness correction with respect to an image in which scenery is represented, the image can be corrected to a sharp image that gives the impression of being in focus in a wide area. By administering brightness correction and contrast correction with respect to an overexposed or underexposed image, the image can be made to approximate an image with the correct exposure. White balance correction is processing that adjusts the gain of RGB in accordance with the lighting environment of the subject. By administering memory color correction with respect to a region in which a person, a red flower, a blue sky, or the green of trees is represented, the hue can be corrected to a hue in which skin color can be beautifully seen, or to a hue in which the red petals are vivid, or to a hue in which the blue sky is clear, or to a hue in which the green of the trees can be corrected to a lively green.

A resolution converting unit 26 serving as a first generating unit and a second generating unit works with the control unit 37 to convert the resolution of the image to a predetermined resolution. Specifically, for example, the resolution converting unit 26 converts an image to a resolution corresponding to shooting conditions that the user sets before shooting or generation conditions that the user sets after shooting, and converts the image to a resolution corresponding to the screen size of an LCD 36.

A compressing/extending unit 28 serving as a first generating unit and a second generating unit compresses an image or extends a compressed image. The compression format may be a reversible compression format or an irreversible compression format. Specifically, for example, the JPEG format or the JPEG 2000 format, in which DCT, wavelet conversion, quantization, Huffman coding and run-length coding are combined, can be adopted. The image can also be stored in a removable memory 48 without being compressed. A quantization table, in which the input levels and the output levels are associated, is used for the quantization. The number of input levels corresponding to one output level is called a quantization step width. The wider the quantization step width is, the higher the compression ratio becomes. It will be assumed that the compression ratio is high when the data amount after compression is small with respect to the data amount before compression. There is less image quality deterioration resulting from compression when the quantization step width is narrow. The control unit 37 can also dynamically set the quantization step width in accordance with the image quality. Specifically, for example, the control unit 37 can curb the suppression of tone resulting from compression by analyzing the image and setting the quantization step width to be small at a level corresponding to a region where the hue changes gradually in a relatively wide range (e.g., a region in which a blue sky with thin clouds is represented).

The above-described functions of the color processing unit 24, the resolution converting unit 26 and the compression/extension unit 28 may be realized by dedicated circuits such as ASIC or DSP, or may be realized by the control unit 37 executing a specific program.

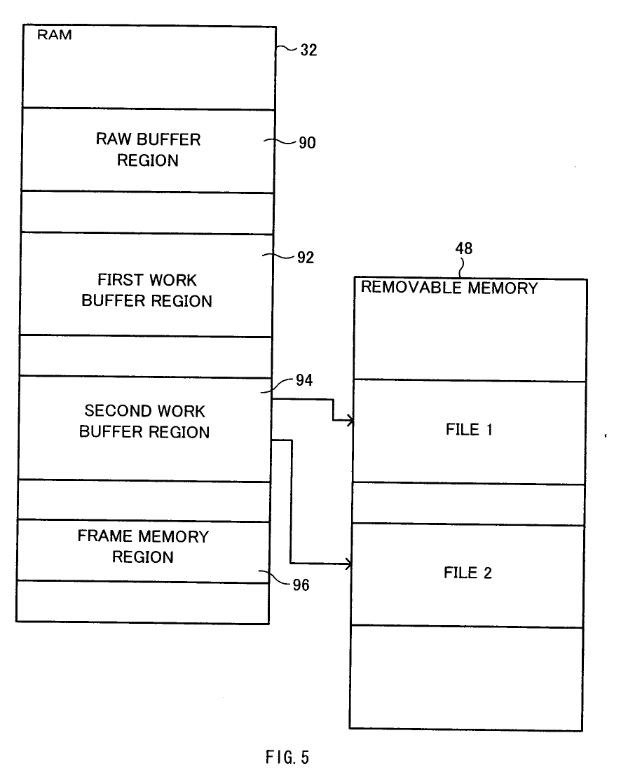

A graphic controller 34 is disposed with a display control circuit including a synthetic function, and displays, alone on the screen of the LCD 36, a display-use image stored in a frame memory region 96 of the RAM 32 (see FIG. 5), or superposes and displays, on the screen of the LCD 36, a menu on the display-use image.

An operation unit 40 is disposed with a release button 50, various types of push buttons 52, 56, 58, 60, 62 and 64 for menu operation and the like, a lever 54, and a jog dial 66.

An external interface controller 42 communicably connects the DSC 1 to an external system such as an unillustrated personal computer (PC). The hard disk of an external device such as a PC can correspond to the nonvolatile storage medium described in the claims.

A removable memory controller 44 serving as an output unit is an input/output mechanism that transfers the data stored in the RAM 32 to the removable memory 48 serving as a nonvolatile storage medium connected to a card connector 46.

A flash memory controller 39 transfers data stored in a flash memory 38 to the RAM 32. The flash memory 38 is a nonvolatile memory that stores an image processing program that a CPU 20 executes. The image processing program necessary for the DSC 1 to run and various types of data can also be stored in the flash memory 38 by downloading them via a network from a predetermined server or by reading them from the removable memory 48.

The control unit 37 is disposed with the CPU 20, the RAM 32 and the RAM controller 30. The CPU 20 controls the units of the DSC 1 by executing the image processing program stored in the flash memory 38. The RAM controller 30 controls data transfer between the RAM 32 serving as a volatile storage medium and the AFE 18, the color processing unit 24, the resolution converting unit 26, the compression/extension unit 28, the CPU 30, the graphic controller 34, the removable memory controller 44, and the flash memory controller 39.

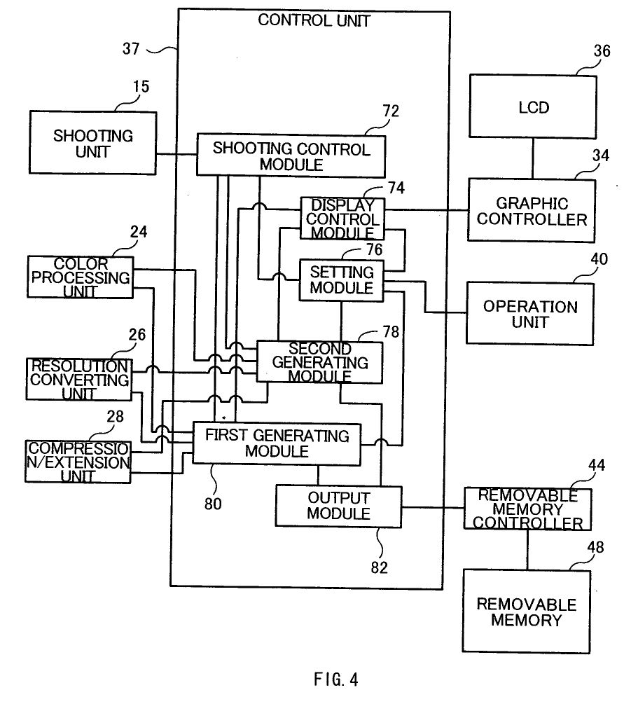

FIG. 4 is a block diagram showing the logical configuration of the image processing program that the control unit 37 executes.

A shooting control module 72 works with the shooting unit 15 when the release button 50 is depressed to generate raw data, and stores the generated raw data in a raw buffer region 90 of the RAM 32 (see FIG. 5).

A first generating module 80 is a program part that causes the control unit 37 to function as a first generating unit. When the release button is depressed, the first generating module 80 works with the color processing unit 24, the resolution converting unit 26 and the compression/extension unit 28 to generate, from the raw data, an output-use image serving as a first image immediately after the raw data have been generated or in parallel with the generation. In the development processing, a first work buffer region 92 and a second work buffer region 94 of the RAM 32 are used. Specifically, for example, an image immediately after development is stored in the first work buffer region 92. An image converted from RGB to another color space such as YCbCr is stored in the second work buffer region 94. The output-use image may be in a format compressed by the compression/extension unit 28 or may be in an uncompressed format. The output-use image may also be a color image or a black-and-white image.

A second generating module 78 is a program part that causes the control unit 37 to function as a second generating unit. The second generating module 78 works with the color processing unit 24, the resolution converting unit 26 and the compression/extension unit 28 to precisely generate, with an algorithm different from that of the first generating module 80, an output-use image serving as a second image from the raw data. For example, the second generating module 78 may execute pixel interpolation at the time of image formation with an algorithm that references more neighboring pixels than the first generating module 80. By referencing more neighboring pixels at the time of image formation, the second generating module 78 can usually interpolate the depletion channel of the target pixel at a more accurate tone level. The second generating module 78 may also cause image processing such as pixel interpolation, density conversion and spatial information conversion to be completed by just the control unit 37. That is, this image processing may also be executed by the control unit 37 alone executing the second generating module 78. By executing with software this image processing executable by the color processing unit 24 and the resolution converting unit 26 configured by dedicated circuits such as ASIC or DSP, the processing time increases but higher image quality can be achieved at a low cost. Conversely, when the color processing unit 24 and the resolution converting unit 26 are configured by ASIC or DSP and execute this processing in cooperation with the first generating module 80 immediately after shooting, the shooting interval can be reduced.

An output module 82 is a program part that causes the control unit 37 to function as an output unit. The output module 82 generates a file of a predetermined format in which are stored the output-use image and predetermined shooting information, and works with the removable memory controller 44 to store the generated file in the removable memory 48.

A setting module 76 is a program part that causes the control unit 37 to function as a setting unit. The setting module 76 works with the operation unit 40 and the graphic controller 34 to receive a setting operation of the shooting conditions and the generation conditions and set the shooting conditions and the generation conditions in accordance with the setting operation. The shooting conditions are conditions that control the characteristics of the output-use image to be generated in response to the depression of the release button 50. Specifically, for example, the shooting conditions are the shutter speed, the aperture, the white balance, the scene mode, the resolution, and the compression conditions. The generation conditions are conditions that control the characteristics of the output-use image, are used when generating the output-use image in accordance with a development request from the raw data generated in response to the depression of the release button 50, and are set after the depression of the release button 50. Specifically, for example, the generation conditions are the exposure correction conditions, the white balance, the scene mode, the resolution, and the compression conditions. The second generating module 78 and the first generating module 80 generate the output-use image on the basis of the generation conditions or the shooting conditions that the setting module has set.

When the generation conditions and the shooting conditions present in the characteristics of the raw data are to be automatically set, such as when the gain of each channel in white balance correction is to be set, the algorithm by which the setting module 76 sets the generation conditions and the algorithm by which the setting module 76 sets the shooting conditions may be different. For example, when the gain of each channel in white balance correction is set as a generation condition, more pixels in the raw data are sampled in comparison to when this is set as a shooting condition. By sampling more pixels in the raw data or the image immediately after development, whether the region of a color close to an achromatic color is bluish or reddish can be more accurately determined. Also, for example, when the gain of brightness correction is set as a generation condition, more pixels in the image immediately after development are sampled in comparison to when this is set as a shooting condition. By sampling more pixels in the image immediately after development, whether the brightness should be raised or lowered can be more accurately determined. Also, for example, when a region targeted for memory color correction is set as a generation condition, the correction target region and the correction parameters of that region can be more accurately determined by sampling more pixels in the image immediately after development in comparison to when this is set as a shooting condition. Also, for example, when a quantization table used in irreversible compression is set as a generation condition, the suppression of tone resulting from compression can be curbed by sampling the image immediately after development and dynamically setting the quantization table according to the image characteristics. These conditions, which are automatically set on the basis of the generation conditions and shooting conditions that are set in accordance with the setting operation of the user, correspond to the processing condition described in the claims.

A display control module 74 is a program part that causes the control unit 37 to function as a display control unit. The display control module 74 works with the resolution converting unit 26 to generate, from the output-use image, a display-use image with a resolution corresponding to the screen size of the LCD 36, and stores the display-use image in the frame memory region 96 of the RAM 32 (see FIG. 5). The display control module 74 works with the graphic controller 34 to display, on the screen of the LCD 36, the display-use image stored in the frame memory region 96.

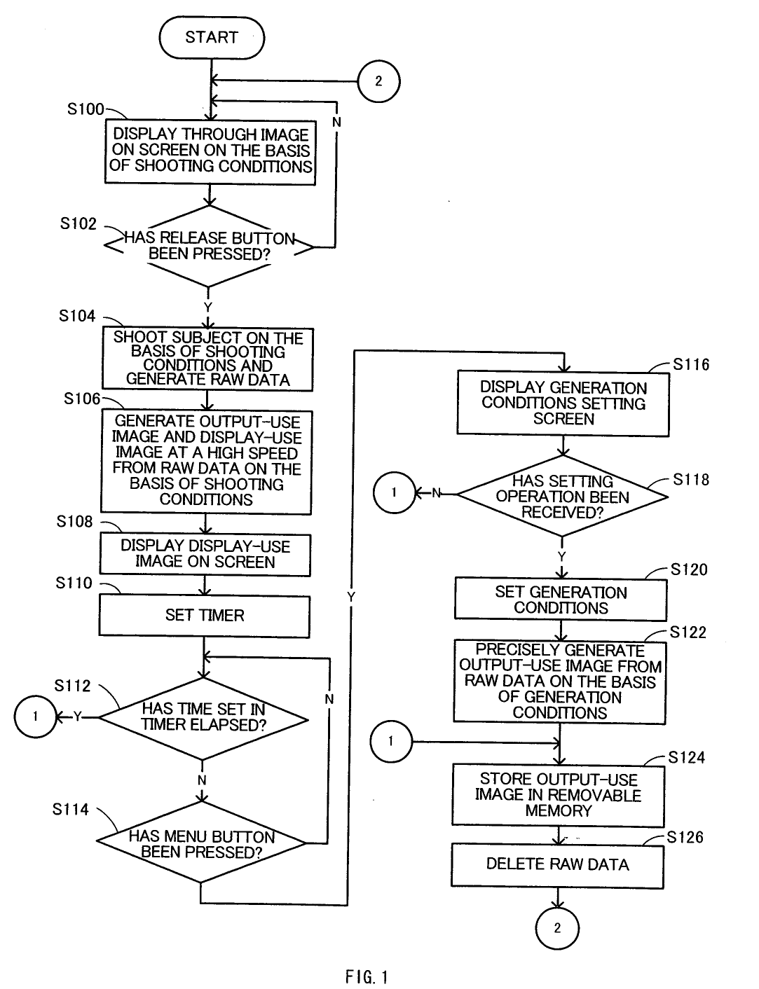

FIG. 1 is a flow chart showing an image processing method according to the DSC 1 that executes, with the control unit 37, the above-described image processing program. The processing shown in FIG. 1 starts when the DSC 1 moves to the shooting mode and is repeated until the DSC 1 moves from the shooting mode to a mode other than the shooting mode.

In step S100, the control unit 37 displays a through image on the screen of the LCD 36 on the basis of the shooting conditions. The shooting conditions are set in accordance with the setting operation that the user conducts in advance. The through image is a series of moving images obtained by shooting, at predetermined time intervals, a subject imaged on the image sensor 14.

In step S102 and step S104, the control unit 37 executes the shooting control module 72, and when the release button 50 is pressed, the control unit 37 works with the shooting unit 15 to shoot the subject on the basis of the shooting conditions and generate raw data. The operation of pressing the release button 50 corresponds to the shooting operation described in the claims. The generated raw data are stored in the raw buffer region 90 of the RAM 32. The shooting conditions used when the raw data are generated are the focal position, the shutter speed, the aperture, and the scene mode, for example. The focal position, the aperture, and the scene mode are conditions that control the lens controller 11 and the aperture controller 13. The scene mode is, for example, a human subject shooting mode where the aperture is widened or a scenery shooting mode where the aperture is narrowed. The shutter speed is a condition that controls the mechanical shutter or the electrical shutter. As described above, the raw data may be data to which white balance correction and gamma correction have been administered.

In step S106, the control unit 37 executes the first generating module 80 and works together with the color processing unit 24, the resolution converting unit 26 and the compression/extension unit 28 to generate at a high speed the display-use image and the output-use image from the raw data on the basis of the shooting conditions. The display-use image is an image with a resolution corresponding to the screen size of the LCD 36. The display-use image is stored in the frame memory region 96 of the RAM 32. The output-use image is stored in either the first work buffer region 92 or the second work buffer region 94. The output-use image is an image with a resolution and compression ratio corresponding to the shooting conditions. The shooting conditions used when generating the display-use image and the output-use image are conditions such as white balance correction, contrast correction, color balance correction, brightness correction, memory color correction, resolution conversion, and compression. In step S106, the control unit 37 may also work with the removable memory controller 44 to store the output-use image in the removable memory 48.

It is preferable for the first generating module 80 to generate the output-use image at a higher speed than the second generating module 78 by working together with the dedicated circuits of the color processing unit 24, the resolution converting unit 26, or the compression/extension unit 28 with more processing than that of the second generating module 78. It is also preferable for the first generating module 80 to generate the output-use image at a higher speed than the second generating module 78 by reducing the number of sampling pixels or the number of sampling times to be less than that of the second generating module 78. The continuous shooting interval can be shortened when the first generating module 80 generates the output-use image at a higher speed than the second generating module 78.

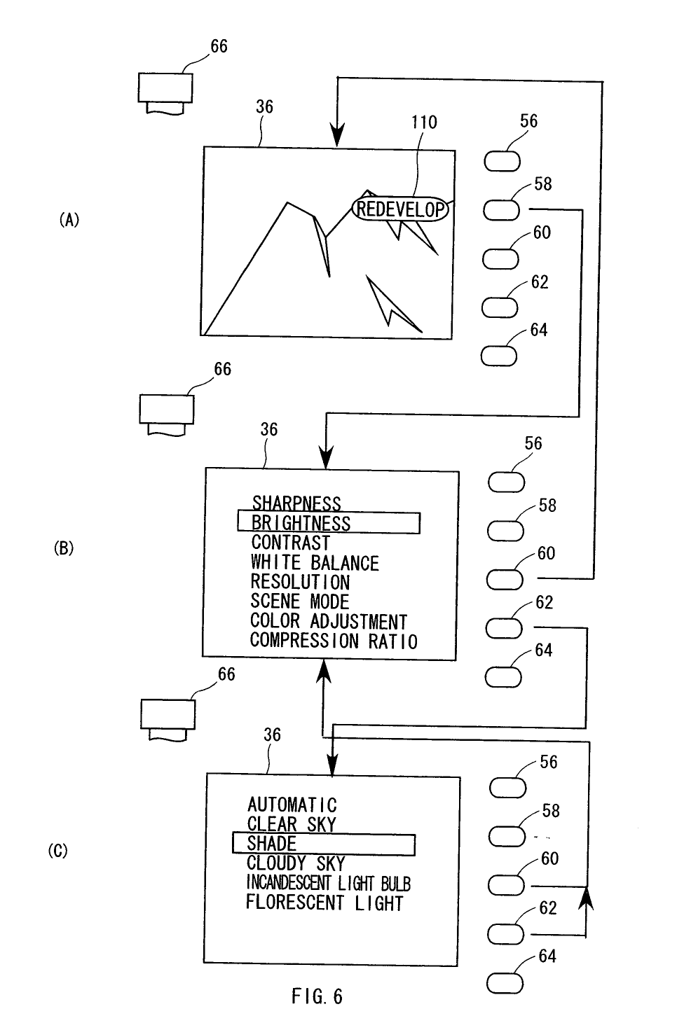

In step S108, the control unit 37 executes the display control module 74 and displays the display-use image on the screen of the LCD 36. At this time, as shown in FIG. 6(A), the control unit 37 superposes and displays, on the display-use image, a guide display 110 for guiding the receiving of the setting operation of the generation conditions serving as a development request with a predetermined button operation. Because the user can confirm the display-use image in which the shooting conditions are reflected before setting the generation conditions on the screen of the LCD 36, the user can set appropriate generation conditions.

In step S110, step S112 and step S114, the control unit 37 sets a predetermined time in a timer and waits for the operation of pressing the button guided by the guide display 110—for example, a menu button 58—until the time set in the timer elapses. If the menu button 58 is pressed during that time, the control unit 37 proceeds to the processing in step S116, and if the menu button 58 is not pressed during that time, the control unit 37 proceeds to the processing in step S124.

In step S116, the control unit 37 displays, on the screen of the LCD 36, a generation condition setting screen for receiving the setting operation of the generation conditions. The selection items of the setting operation of the generation conditions are items that determine conditions such as sharpness correction, brightness correction, contrast correction, white balance correction, resolution conversion, scene mode correction, color balance correction, and compression. The control unit 37 may cause the selection items of the setting operation of the generation conditions to be displayed in a hierarchical menu or in a single hierarchy menu. The generation condition setting screen guiding the user to the higher selection items in the hierarchy is as shown in FIG. 6(B), for example.

In step S118 and step S120, the control unit 37 executes the setting module 76 and waits for the setting operation of the generation conditions. When the setting operation is conducted, the control unit 37 sets the generation conditions in accordance with the setting operation. If the setting operation has not been conducted, then the control unit 37 proceeds to the processing in step S124. The setting operation of the generation conditions is received as follows, for example. The user selects any of the selection items of sharpness, brightness, contrast, white balance, resolution, scene mode, color adjustment and compression ratio by rotating the jog dial 66 in a state where the screen shown in FIG. 6(B) is displayed. The user presses a predetermined button such as a determination button 62 in a state where any of the selection items has been selected, whereby a menu of selection items determining the generation conditions in regard to the selected selection item is displayed on the screen.

The menu is as shown in FIG. 6(C), for example. The user selects any of the selection items by rotating the jog dial 66 in a state where the screen shown in FIG. 6(C) is shown. The user presses a predetermined button such as the determination button 62 in a state where any of the selection items has been selected, whereby the control unit 37 sets the generation condition corresponding to the selected selection item and again displays the screen shown in FIG. 6(B). However, at this stage, the processing conditions that are to be automatically set in accordance with the characteristics of the raw data are not set; rather, parameters for setting the final processing conditions are set. Specifically, for example, when “automatic” is selected in the screen shown in FIG. 6(C), a parameter where the gain of each channel in white balance correction is set in accordance with the sampling result of the raw data is set. Then, at the stage when the output-use image is to be actually generated, the optimum gain of each channel is set on the basis of this parameter. Of course, even in this case, the control unit 37 may reference the raw data at this stage and automatically set the optimum processing conditions. When the user presses, for example, a cancel button 60 in a state where the screen shown in FIG. 6(C) is displayed, the control unit 37 again displays the screen shown in FIG. 6(B) without setting the generation conditions. When the user presses a predetermined button such as a function button 64 in a state where the screen shown in FIG. 6(B) is displayed, the control unit 37 proceeds to the processing in step S122. This operation corresponds to the development request described in the claims.

In step S122, the control unit 37 executes the second generating module 78 and works with the color processing unit 247, the resolution converting unit 26 and the compression/extension unit 28 to precisely generate the output-use image from the raw data on the basis of the generation conditions. The output-use image is stored in either the first work buffer region 92 or the second work buffer region 94. The second generating module 78 precisely generates the output-use image with an algorithm that is different from that of the first generating module 80 and overwrites the output-use image generated by the first generating module 80 with the output-use image that it has generated. Specifically, for example, more pixels are sampled in regard to the raw data or the image immediately after development as described above, more accurate processing conditions are automatically set, and the output-use image is generated on the basis of the automatically set processing conditions. Also, for example, an image after development is sampled in order to set the quantization table used in irreversible compression, and a quantization table corresponding to the characteristics of the image is dynamically set on the basis of the sampling result. Also, for example, more processing is executed by the control unit 37 alone, and the output-use image is generated by more detailed conditional branch processing corresponding to the characteristics of the image. As a result of this processing, the output-use image overwritten by the second generating module 78 becomes a higher quality image in comparison to the output image generated by the first generating module 80.

The control unit 37 may also display, on the screen of the LCD 36, an output-use image generated on the basis of the generation conditions and receive an operation redoing the setting operation of the generation conditions or an operation confirming the setting content. Thus, the user can repeat the setting operation of the generation conditions until image quality with which the user can be satisfied is obtained, and generate an image from the raw data on the basis of the optimum generation conditions. The first generating module 80 may also generate an output-use image on the basis of the shooting conditions without receiving the setting operation of the generation conditions. Even in this case, the second generating module 78 can generate a higher quality image in comparison to the output image generated by the first generating module 80, by precisely generating an output-use image with an algorithm that is different from that of the first generating module 80.

In step S124, the control unit 37 executes the output module 82, generates a file of a predetermined format, such as an EXIF format file, in which are stored the output-use image and shooting information corresponding to the shooting conditions or generation conditions, and works with the removable memory controller 44 to store the file in the removable memory 48.

In step S126, the control unit 37 deletes the raw data stored in the raw buffer region 90 of the RAM 32.

According to the first embodiment of the invention described above, when an output-use image is to be generated in accordance with an operation after the shooting operation, the output-use image is precisely generated with an algorithm that is different from when an output-use image is generated in accordance with the shooting operation, whereby a high-quality output-use image can be generated. Also, when an output-use image is to be generated in accordance with the shooting operation, the output-use image is generated imprecisely in comparison to when an output-use image is generated in accordance with an operation after the shooting operation, whereby an output-use image can be generated at a high speed.

### Second Embodiment

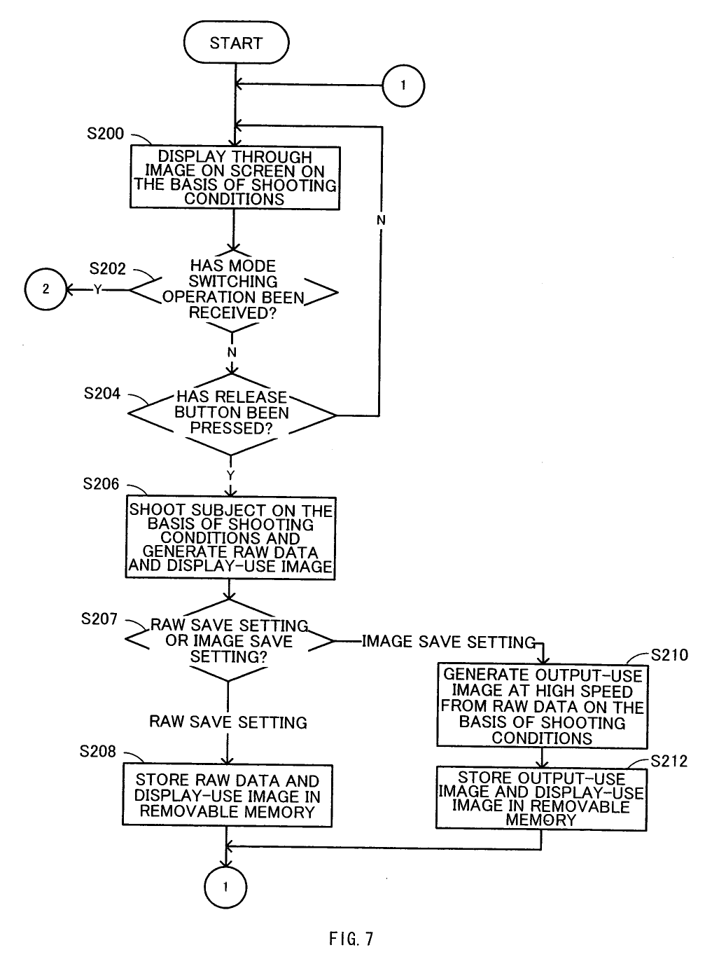

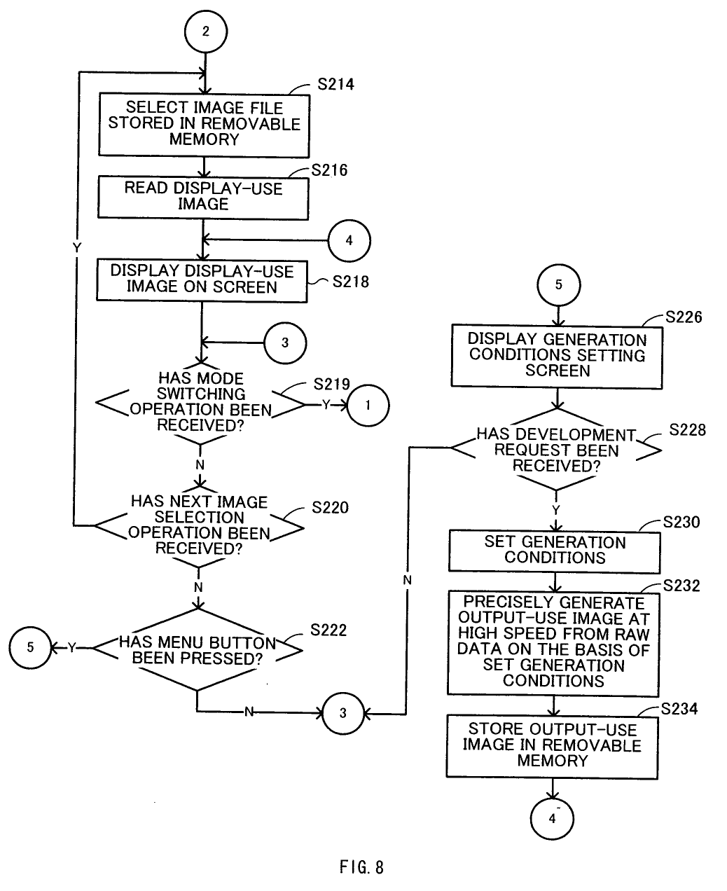

FIG. 7 and FIG. 8 are flow charts showing an image processing method according to a second embodiment of the invention. The processing shown in FIG. 7 and FIG. 8 starts when the power of the DSC 1 is turned ON and is repeated until the power of the DSC 1 is turned OFF.

In step S200, step S202 and step S204, the control unit 37 waits for a mode switching operation and a shooting operation while displaying a through image on the screen of the LCD 36 on the basis of the shooting conditions. When a mode switching operation is received, the control unit 37 proceeds to the processing in step S214, where the DSC 1 moves to the playback mode. When the release button 50 is pressed and a shooting operation is received, the control unit 37 proceeds to the processing in step S206.

In step S206, the control unit 37 executes the shooting control module 72 and works with the shooting unit 15 to shoot a subject on the basis of the shooting conditions and generate raw data. The generated raw data are stored in the raw buffer region 90 of the RAM 32.

In step S207, the control unit 37 determines whether either of a raw save setting or an image save setting has been set by a setting operation of the shooting conditions conducted before the shooting operation. If the raw save setting has been set, the control unit 37 proceeds to the processing in step S208, and if the image save setting has been set, the control unit 37 proceeds to the processing in step S210. The raw save setting is a setting for saving the raw data in the removable memory without doing development processing. The image save setting is a setting for saving the output-use image generated by the development processing in the removable memory.

In step S208, the control unit 37 executes the output module 82, generates a file of a predetermined format in which are stored the raw data and a display-use image, and works with the removable memory controller 44 to store the file in the removable memory 48. At this time, the control unit 37 may also execute the first generating module 80, generate an output-use image at a high speed, and store the output-use image in the file.

In step S210, the control unit 37 executes the first image generating module 80 and work with the color processing unit 24, the resolution converting unit 26 and the compression/extension unit 28 to generate an output-use image at a high speed from the raw data on the basis of the shooting conditions.

In step S212, the control unit 37 executes the output module 80, generates a file of a predetermined format, such as an EXIF format file, in which are stored the display-use image, the output-use image, and shooting information corresponding to the shooting conditions, and works with the removable memory controller 44 to store the file in the removable memory 48.

In step S214, the control unit 37 selects the image files stored in the removable memory 48. The order in which the image files are selected may be in the order of shooting or in the file of file name.

In step S216, the control unit 37 works with the removable memory controller 44 to store, in the frame memory region 96 of the RAM 32, the display-use image stored in the selected image file.

In step S218, the control unit 37 executes the display control module 74 and works with the graphic controller to display the display-use image on the screen of the LCD 36. At this time, when raw data are being stored in the image file being selected, the control unit 37 superposes and displays, on the display-use image, the guide display 110 for guiding the receiving of the development request with a predetermined button operation, as shown in FIG. 6(A).

In steps S219, step S220, and step S222, the control unit 37 waits for a mode switching operation, a next image selection operation, and a generation conditions setting request. When the control unit 37 receives a mode switching operation, it proceeds to the processing in step S200, and as a result the DSC 1 moves to the shooting mode. When the control unit 37 receives a next image selection operation, it proceeds to the processing in step S214. The next image selection operation is received when the user rotates the jog dial 66, for example. When the control unit 37 receives a generation conditions setting request, it proceeds to the processing in step S226. The generation conditions setting request is received when the user presses the menu button 58, for example.

In step S226, the control unit 37 displays a generation conditions setting screen on the screen of the LCD 36.

In step S228 and step S230, the control unit waits for a setting operation of the generation conditions. When a setting operation is conducted, the control unit executes the setting module 76 and sets the generation conditions in accordance with a development request. If a development request is not conducted, the control unit 37 proceeds to the processing in step S219.

In step S232, the control unit 37 executes the second generating module 78 and works with the color processing unit 24, the resolution converting unit 26 and the compression/extension 28 to precisely generate an output-use image on the basis of the generation conditions from the raw data stored in the selected image file.

In step S234, the control unit 37 executes the output module 80, generates a file of a predetermined format, such as an EXIF format file, in which are stored the display-use image, the output-use image, and shooting information corresponding to the shooting conditions and generation conditions, and works with the removable memory controller 44 to store the file in the removable memory 48.

According to the second embodiment of the invention described above, when an output-use image is to be generated from raw data in the playback mode, which is not a mode where the user immediately tries to start a shooting operation, the output-use image is precisely generated in comparison to when the output-use image is generated in accordance with the shooting operation, whereby a high-quality output-use image can be generated.

### Third Embodiment

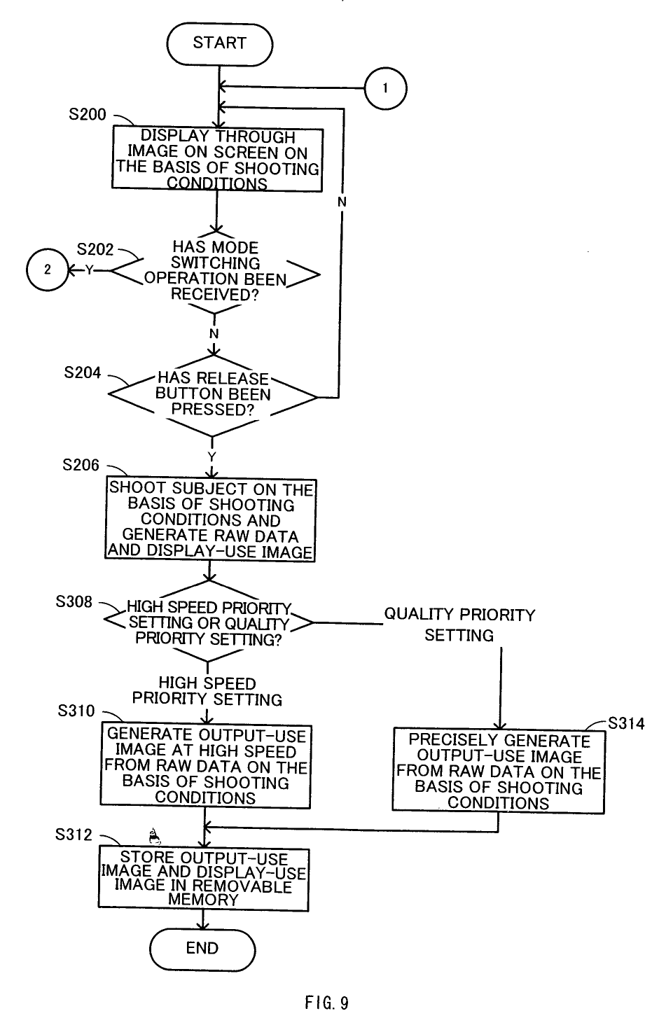

FIG. 9 is a flow chart showing an image processing method according to a third embodiment of the invention. The processing shown in FIG. 7 starts when the power of the DSC 1 is turned ON and is repeated until the power of the DSC 1 is turned OFF.

In step S200 to step S206, the raw data and display-use image are generated in the same manner as in the above-described second embodiment.

In step S308, the control unit 37 determines whether either of a high speed priority setting or a quality priority setting has been set by a setting operation of the shooting conditions conducted before the shooting operation. If a high speed priority setting has been set, then the control unit 37 proceeds to the processing in step S310, and if a quality priority setting has been set, then the control unit 37 proceeds to the processing in step 314. The high speed priority setting is a setting that generates an output-use image at a high speed from the raw data in order to shorten the continuous shooting interval. The quality priority setting is a setting that precisely generates an output-use image from the raw data in order to raise the quality of the output-use image. When the control unit 37 and the operation unit 40 receive a setting operation of the shooting conditions conducted before the shooting operation, they function as the pre-shooting selection unit described in the claims.

In step S310, the control unit 37 executes the first generating module 80 and works with the color processing unit 24, the resolution converting unit 26 and the compression/extension unit 28 to generate an output-use image at a high speed from the raw data on the basis of the shooting conditions.

In step S314, the control unit 37 executes the second generating module 78 and works with the color processing unit 24, the resolution converting unit 26 and the compression/extension unit 28 to precisely generate an output-use image from the raw data on the basis of the shooting conditions.

In step S312, the control unit 37 executes the output module 80, generates a file of a predetermined format, such as an EXIF format file, in which are stored the display-use image, the output-use image, and shooting information corresponding to the shooting conditions, and works with the removable memory controller 44 to store the file in the removable memory 48.

According to the third embodiment of the invention described above, the user can select, before the shooting operation, whether to generate an output-use image at a high speed or precisely generate an output-use image, can generate an output-use image at a high speed on the basis of the setting corresponding to the selection, and can generate a high-quality output-use image.

The high speed priority setting or the quality priority setting may also be configured to be selectable on the generation conditions setting screens shown in FIG. 6(B) and FIG. 6(C). In this case, the processing shown in step S232 of FIG. 8 is executed by either the first generating module 80 or the second generating module 78 in accordance with the high speed priority setting or the quality priority setting. Also, when the control unit 37 and the operation unit 40 receive a high speed priority setting operation or a quality priority setting operation conducted after the shooting operation, they function as the post-shooting selection unit described in the claims.

Combinations and sub-combinations of the various embodiments described above will be apparent to those skilled in the art insofar as they do not deviate from the scope and gist of the invention.

What is claimed is:

1. A digital camera comprising:
a shooting unit that generates, in accordance with a shooting operation, raw data representing a tone level of one channel per pixel;
a first generating unit that generates a first image from the raw data; and
a second generating unit that generates a second image from the raw data more precisely than the first generating unit with an algorithm that is different from that of the first generating unit.

2. The digital camera of claim 1, wherein the second generating unit realizes, with software, a function that a dedicated circuit configuring at least part of the first generating unit realizes.

3. The digital camera of claim 1, wherein the number of pixels of the shooting unit corresponding to data that the second generating unit references in order to automatically set a processing condition for generating the second image is greater than the number of pixels of the shooting unit corresponding to data that the first generating unit references in order to automatically set a processing condition for generating the first image.

4. The digital camera of claim 3, wherein the processing condition is used in white balance correction.

5. The digital camera of claim 3, wherein the processing condition is used in brightness correction.

6. The digital camera of claim 3, wherein the processing condition is used in memory color correction.

7. The digital camera of claim 3, wherein the processing condition is used in image compression.

8. The digital camera of claim 1, wherein the number of pixels of the shooting unit corresponding to data that the second generating unit references in order to generate one pixel of the second image is greater than the number of pixels of the shooting unit corresponding to data that the first generating unit references in order to generate one pixel of the first image.

9. The digital camera of claim 1, further comprising an output unit that stores data in a nonvolatile storage medium, wherein
the second generating unit generates, from the raw data stored in the nonvolatile storage medium, the second image in accordance with a development request after the shooting operation, and
the output unit stores, in the nonvolatile storage medium and in accordance with the shooting operation, at least one of the raw data that the shooting unit has generated and the first image that the first generating unit has generated in accordance with the shooting operation, and stores, in the nonvolatile storage medium and in accordance with the development request, the second image that the second generating unit has generated.

10. The digital camera of claim 9, further comprising
a setting unit that receives, after the shooting operation, a setting operation of a generation condition for the second generating unit to generate the second image, and sets the generation condition in accordance with the setting operation, and
a display control unit that displays, on a screen and before receiving the setting operation of the generation condition, the first image stored in the nonvolatile storage medium.

11. The digital camera of claim 1, further comprising a volatile storage medium and an output unit that stores data in a nonvolatile storage medium, wherein
the shooting unit stores the raw data in the volatile storage medium in accordance with the shooting operation,
the first generating unit generates, from the raw data stored in the volatile storage medium, the first image in accordance with the shooting operation,
the second generating unit generates, from the raw data stored in the volatile storage medium, the second image in accordance with a development request after the shooting operation, and
the output unit stores, in the nonvolatile storage medium and in accordance with the shooting operation, the first image that the first generating unit has generated, and stores, in the nonvolatile storage medium and in accordance with the development request, the second image that the second generating unit has generated.

12. The digital camera of claim 11, further comprising
a setting unit that receives, after the shooting operation, a setting operation of a generation condition for the second generating unit to generate the second image, and sets the generation condition in accordance with the setting operation, and
a display control unit that displays, on a screen and before receiving the setting operation of the generation condition, the first image stored in the nonvolatile storage medium.

13. The digital camera of claim 1, further comprising a pre-shooting selection unit that receives, before the shooting operation, a pre-shooting selection operation for selecting either the first image or the second image, and causes, in accordance with the pre-shooting selection operation, either the first generating or the second generating unit to generate the first image or the second image in accordance with the shooting operation.

14. The digital camera of claim 1, further comprising a post-shooting selection unit that receives, after the shooting operation, a post-shooting selection operation for selecting either the first image or the second image, and causes, in accordance with the development request after the shooting operation, either the first generating or the second generating unit to generate the first image or the second image.

15. An image processing method of generating an image with a digital camera, the method comprising:
a shooting step that generates, in accordance with a shooting operation, raw data representing a tone level of one channel per pixel;
a first generating step that generates a first image from the raw data; and
a second generating step that generates a second image from the raw data more precisely than the first generating unit with an algorithm that is different from that of the first generating unit.
